(19) United States
(12) Patent Application Publication
(10) Pub. No.: US 2002/0085017 A1
(43) Pub. Date: Jul. 4, 2002

(54) Method and apparatus for reordering data items displayed on an electronic device

(76) Inventors: Suthirug Num Pisutha-Arnond, St. Charles, MO (US); Sheila Renee Crosby, Crystal Lake, IL (US); Eric Christensen, Buffalo Grove, IL (US); Byron Macon Brewer III, Chicago, IL (US)

Correspondence Address: Motorola, Inc., Intellectual Property Dept. (RKB), 600 North US Highway 45, AN475, Libertyville, IL, 60048, US

(21) Appl. No.: 09/753,861

(22) Filed: Jan. 3, 2001

(51) Int. Cl. G09G 5/00

(52) U.S. Cl. 345/660

(57) ABSTRACT

A portable electronic device, for example a personal communications device, having a display on which a user may relocate and reorder display items by selecting a display item to be relocated, designating a new display position on the display to which the selected display is to be moved, and inserting the selected display item into the new display position after designating the new position.

### BACKGROUND OF THE INVENTION

The present invention relates generally to electronic devices with data displays, and more particularly to portable electronic devices having user configurable menus.

Portable electronic devices that display information, including data entered by the user are well known, and include for example pagers, cellular telephones, personal digital assistants (PDAs), cameras and video devices, radios and hand held global positioning system (GPS) devices, among many other devices.

The displayed data often includes menu entries such as commands, and general data items including names and telephone numbers and other alphanumeric information, which may be added and deleted at the user's convenience.

The known portable electronic devices, however, do not allow the user to control the arrangement of information on the display, for example the order of menu item entries and other data. The display of menu data entries are typically ordered by the manufacturer, and user-stored data is typically displayed either in the order that it is entered or in alphabetical or numerical or some other predetermined order.

An object of the present invention is to provide novel portable electronic devices that improve upon and overcome problems in the art.

Another object of the invention is to provide in some embodiments thereof novel portable electronic devices that permit users to rearrange the display of information on a display thereof.

Another abject of the invention is to provide in some embodiments thereof novel portable electronic devices, for example cellular telephones, that allow user to relocate and reorder menu data entries displayed on a display thereof.

Another object of the invention is to provide in some embodiments thereof novel portable electronic devices that allow users to reorder the display of listed data items according to the particular desires of the user, for example by frequency of use, or by relative importance, or alphabetically, or numerically, etc.

A more particular object of the invention is to provide in some embodiments thereof novel methods for relocating display items displayed on a display in a portable electronic device, comprising designating a display item displayed at an initial position on the display for relocation, specifying a destination position of the selected display item, and inserting the selected display item in the destination position.

Another more particular object of the invention is to provide in some embodiments thereof novel methods for reordering data items displayed on a display menu of a portable personal communications device, comprising selecting a data item to be relocated, repositioning the selected data item to a new position on the display menu, and inserting the selected data item in the new position after repositioning.

It is yet another more particular object of the invention to provide in some embodiments thereof novel processor based portable electronic devices having a display, memory and user operable inputs, comprising a plurality of display items displayed on the display, a display item selection input for selecting a display item to be relocated, a display item relocation input for moving the selected display item to a new location on the display, a display item insertion input for inserting the selected display item in the new location.

The foregoing objects, features and advantage of the present invention will be appreciated more fully by those having ordinary skill in the art fully upon considering the following Detailed Description of the Invention in conjunction with the Drawings described below.

### BRIEF DESCRIPTION OF THE DRAWINGS

FIG. 1 illustrates a flow chart for practicing an exemplary method of the present invention;

FIG. 2 illustrates a series of data items on a cellular telephone menu being reordered;

FIG. 3 illustrates a similar reordering to that in FIG. 2 except the data item being reordered is moved from a bottom position to a topmost position in the cellular telephone menu;

FIG. 4 illustrates relocation of a data item where the data item is moved from the top of the menu to the bottom of the menu, with an empty location existing in the menu;

FIG. 5 illustrates a similar reordering to that shown in FIG. 4 except the data item is moved from the bottom of the menu to the top of the menu and the empty data item is now moved to the bottom of the menu;

FIG. 6 illustrates a flowchart for practicing another exemplary method of the invention;

FIG. 7 illustrates an embodiment of a device having exemplary soft keys; and

FIG. 8 illustrates an embodiment of an apparatus for implementing methods of the invention.

### DETAILED DESCRIPTION OF THE INVENTION

The methods of the present invention allow users to reorganize the display items on electronic device displays.

The display items include for example icons, menu entries, data items, including names and telephone numbers, addresses, operational commands, radio frequencies, shortcuts, and other alphanumeric information, among other information, some of which may be entered and manipulated by the user.

The methods of the present invention are useful in portable electronic devices having displays, for example personal communications devices including pagers, cellular telephones, personal digital assistants (PDAs), among other devices, some of which are discussed above in the Background of the Invention.

According to the inventions generally, upon entering a display reconfiguration mode of the electronic device, a user may designate display items to be relocated from an initial position to some other position. The device then enters a display item relocation mode whereupon the user indicates a destination position for the designated display item. The display unit is then inserted in the destination position either directly or by incrementally stepping through one or more intermediate positions.

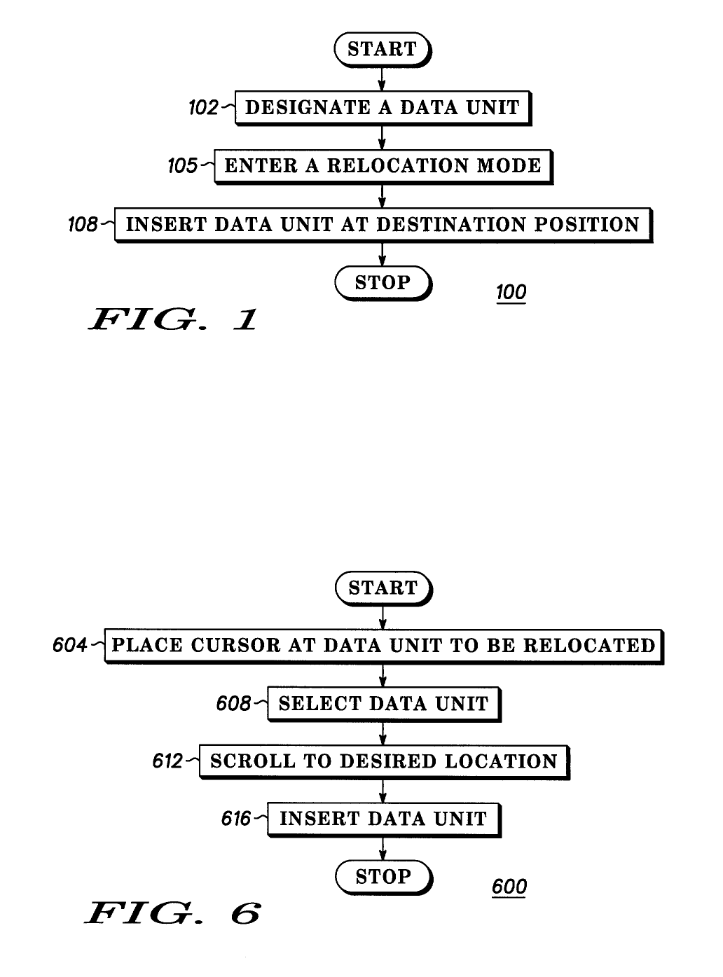

FIG. 1 illustrates a flow chart 100 of an exemplary process for practicing the present invention. Initially, the electronic device enters a display reconfiguration mode, for example by selecting a “Relocate” or “Reorder” function associated with a hard or soft input of the electronic device.

In step 102, a displayed item is designated for relocation from a starting or initial position on the display. The user may designate the display item to be relocated through use of an input on the electronic device, as discussed further below.

In one embodiment, a visual attribute is displayed in association with the selected display item to indicate that the display item has been selected for relocation. The visual attribute may be for example a highlight or a reverse highlight on the selected item, or a blinking of the selected item. Alternatively, that attribute may be a visual symbol associated the selected data item, for example a check mark or an arrow or a triangle or some other indicium located near the selected display item. If stored display items are numbered or already have a symbol associated therewith, the numbering or pg,6 other associated symbol may be replaced with another number or symbol indicating that the display item has been selected for relocatoin.

The electronic device may also include a “Cancel” input to deselect a selected data item in the event of an input error or a change in the user's intent. In embodiments where an attribute is associated with the selected item, actuation of the “Cancel” command may remove or disassociate the attribute from the seleted data item.

Alternatively, the display item may be selected by placing a display cursor on the item with a cursor or some other input of the device, and then attaching the cursor to the display item or grabbing the display item by operating a select input of the device. In this embodiment, the selected display item may be deselected by releasing the select input, instead of using the “Cancel” input discussed above.

In step 105, the device enters a data relocation mode. During this mode, the user specifies a destination position for the designated or selected display item or items. In one embodiment, the selected display item may be scrolled to the new location as discussed further below. In another embodiment, the selected display item may be dragged to the new location, for example with a cursor input of the device. And in yet another embodiment, the destination location may be designated with a destination indicium, whereupon the selected display item is inserted in the destination position during an insertion mode of operation, discussed further below.

In step 108, the display item is inserted at the destination position, for example by depressing an insert input of the device. In embodiments where the selected data item is scrolled or dragged to the new location, operation of the select input consummates the relocation. In embodiments where the new location is marked with a destination indicium, operation of the select input results in the movement and subsequent insertion of the selected data item in the new location.

In this manner, a user may arrange display items in an intuitive fashion by selecting a display item for relocation, selecting a destination position for the selected display item, and inserting the selected data item in the destination position. In some pg,7 embodiments, multiple display items may be moved about the display while the electronic device is in the display reconfiguration mode.

Upon reconfiguring the display items, the display reconfiguration mode of the electronic device may be terminated, for example by selecting a “Done” function displayed on the menu or by operating some other input of the device.

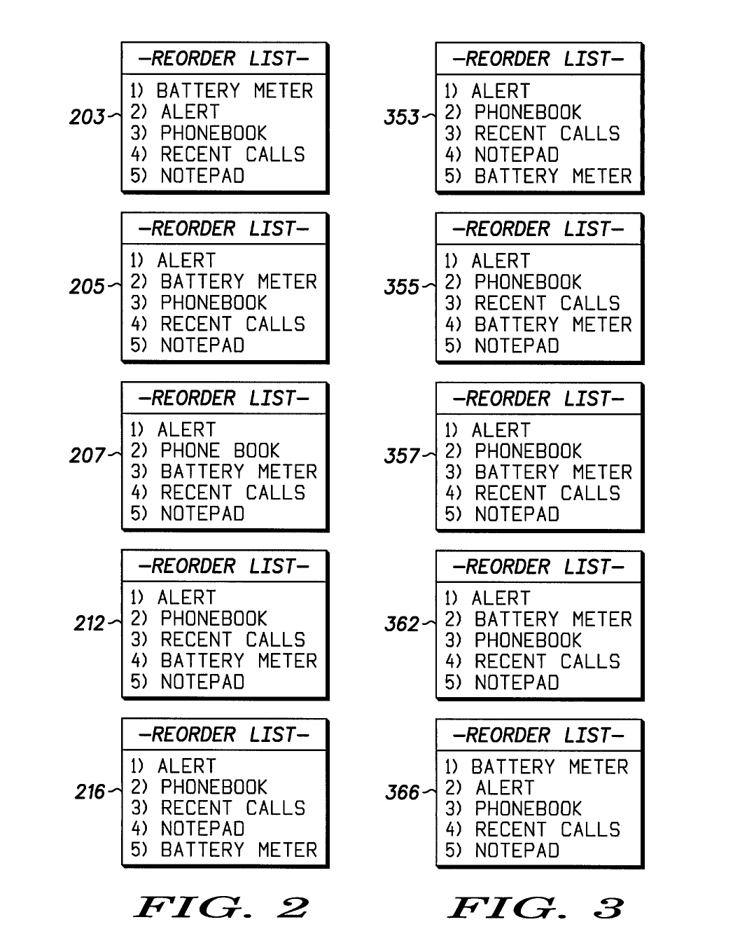

FIG. 2 illustrates a series of menu entry data items, or units, and the reordering thereof on a cellular telephone menu. The cellular telephone menu is an exemplary application, however, as the methods apply to other devices and other types of displayed information as discussed above. Frame 203 illustrates the menu entries before reordering, illustrating a pre-existing order of the menu items, for example according to a default order of the device or according to a prior reordering by the user.

In frame 205 the user designates entry number 2, the “Battery Meter”, as the data item to be relocated and has started to scroll the selected item through intermediate positions in a downward direction. This movement continues through frames 207 and 212, and ends at frame 216. In frame 216, the user has inserted the “Battery Meter” data item at the bottom of the menu at a destination position.

FIG. 3 illustrates another menu entry reordering similar to that shown in FIG. 2 except the designated data item, in frames 353, 355, 357, 362 and 366, is moved from a bottom display position to a topmost display position in the menu, with all other data items remaining in their relative positions.

FIG. 4 illustrates relocation of a menu entry data item where the item, the “Battery Meter”, is moved from the top of the menu to the bottom thereof, with an empty menu location existing in the menu. The data item is selected in frame 403 and successively moved down through intermediate positions in frames 407 and 411. In frame 415, the empty storage location is moved to the top of the list and the items above the data unit are moved down in accommodation. This mode of operation is only exemplary. Alternatively, the empty data location, or item, could remain where it is in the order. In frame 418, the “Battery Meter” item is moved to the very bottom position with the empty data item positioned at the top of the menu. pg,8

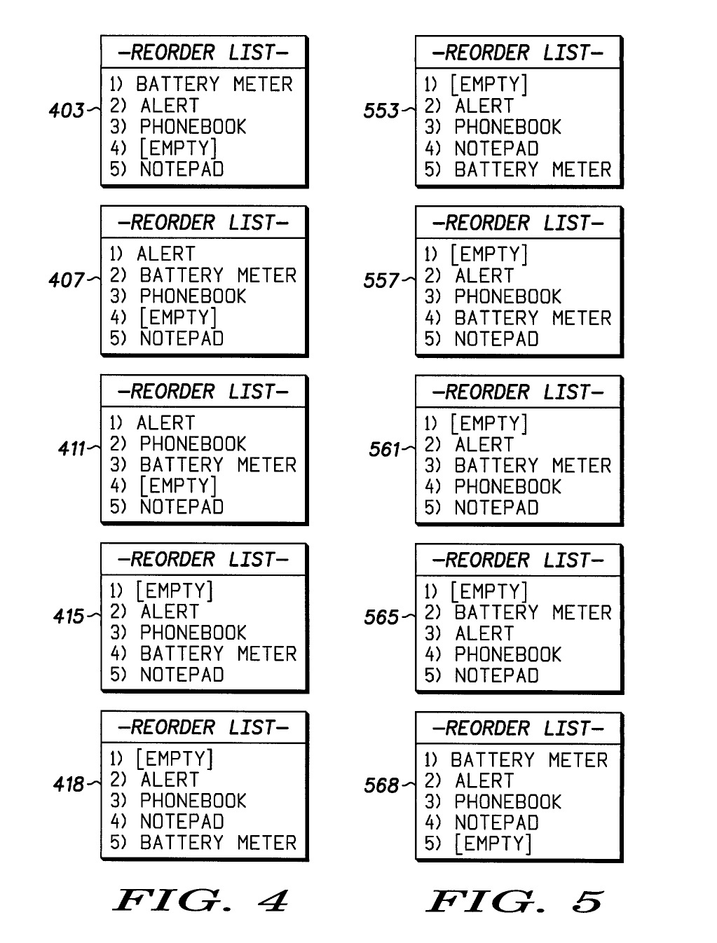

FIG. 5 illustrates a menu entry reordering similar to that of FIG. 4 except the data unit, in frames 553, 557, 561, 565 and 568, is moved from the bottom of the menu to the top of the menu, and the empty data unit is moved to the bottom of the menu.

Any empty data item or entries may be moved to the top or the bottom of the menu as shown above, or may be left in the original order. In addition, empty data items may be selected by the user and may be moved up or down within the menu (or other displayed data) to eliminate gaps in the menu. Thus in some embodiments, the user may segregate all empty data locations at the bottom or top of the menu, for example to eliminate scrolling steps and to make menu use easier.

FIG. 6 illustrates a flowchart 600 of another exemplary process for practicing the invention in an electronic device. Initially, the electronic device is set to operate in the display reconfiguration mode, as discussed above. Thereafter, in step 604, the user places a cursor or other visual display selector at a data unit, or more generally a display item, to be relocated.

In step 608, the user selects the data unit at its initial position on the display. This may be performed, for example, by a grab operation, performed by an operation of an input, for example a soft key, on the electronic device.

In step 612, the user scrolls the selected display item to a new location. This is commonly performed, for example, with up and down scroll inputs on the electronic device. A scrolling operation moves the selected data unit through intermediate positions, if necessary, before placing the data unit at the destination position. Alternatively, the selected data item may be dragged to the new location with a cursor positioning input.

In step 616, the moved display item is inserted in the new destination location. Upon scrolling to the new location, the user may select an insert function button or some other input on the device to insert the data item at the desired location.

The various functions discussed above may be performed by a variety of input devices. In one embodiment, the selections are performed with soft input keys or with a cursor input or some other input. pg,9

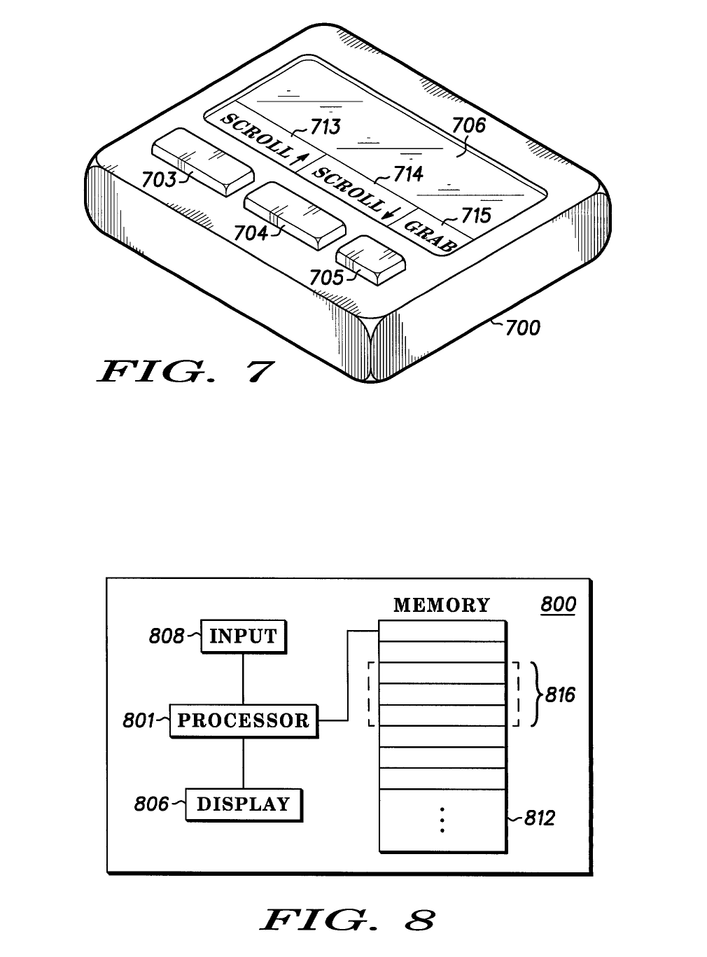

FIG. 7 illustrates an embodiment of a device 700 having exemplary soft input keys 703, 704 and 705. The keys may be located near a perimeter of a display 706, with each key 703, 704 and 705 being associated with a corresponding software controlled function display 713, 714 and 715. The exemplary functions displayed are select, grab, scroll or insert, depending on the current mode of operation. A change in device operating mode may be reflected by a change in the displayed functions 713, 714 and 715. In the designating mode, for example, the display function 715 may be “Grab”, and in some embodiments a “Cancel” function may also be displayed. In the relocation mode the display function 715 may be “Insert”. Individual inputs for each function do not need to exist on the device, which may instead include one or more software configured input keys for performing the various functions.

Alternatively, the device may include individual input keys to accomplish the select, reposition, cancel, insert and other functions, or some other input or inputs that may be reconfigured by the device to perform these functions.

FIG. 8 illustrates an embodiment of a device 800 for implementing the methods of the present invention. The exemplary apparatus 800 includes a processor 801 that communicates with a display 806, an input or inputs 808 and a memory 812. The processor 801 may be any type of general-purpose processor. The display 806 may be any type of display device, such as a liquid crystal display (LCD), fluorescent display, cathode ray tube (CRT), or other display device. The input 808 may be a keyboard, a pointing device or a touch screen display, for example. The memory 812 contains a plurality of data cells. The memory 812 may be a random access memory (RAM), a read-only memory (ROM), or any other type of magnetic or optical memory, including disc or tape storage devices. The memory 812 may contain both program instructions installed by the manufacturer or user to operate the device 800 and may also contain user-stored data such as, for example, names and telephone numbers, etc. A portion of the memory 812 may be displayed data 816. The displayed data 816 may, but does not necessarily, include all data cells in the memory 812. pg,10

In operation, the processor 801 reads program instructions out of the memory 812, receives inputs from the input 808, and generates characters and/or graphics on the display 806. The user may use the input 808 to control the operation of the electronic device 800. The user may for example manipulate the input 808 to reorder the displayed memory units 816 by pressing input keys to select a display item to be moved, scrolling and selecting a destination position, and inserting the data unit at the destination position.

While the present invention has been described to enable those of ordinary skill in the art to make and use what is presently considered to be the best modes thereof, those of ordinary skill will understand and appreciate that equivalents, modifications and variations maybe made thereto without departing from the principals and scope thereof, which is to be limited not by the exemplary embodiments herein but by the scope and spirit of the appended claims. pg,11

What is claimed is:

1. A method for relocating a display item displayed on a display of a portable electronic device, comprising:
designating a display item displayed at an initial position on the display for relocation by selecting the display item;
specifying a destination position of the selected display item; and
inserting the display item in the destination position by entering an insert input of the electronic device after specifying the destination position,
whereby users of the electronic device can selectively rearrange the display of display items on the electronic device.

2. The method of claim 1, selecting the display item by displaying a visual attribute associated the selected display item.

3. The method of claim 2, specifying the destination position by moving the selected display item to the destination position. pg,12

4. The method of claim 1, selecting the display item by grabbing the display item with an input of the electronic device, specifying the destination position of the selected display item by moving the selected display item to a different location on the display.

5. The method of claim 1, the display item is a data item in a menu entry list, selecting the data item by displaying a symbol near the selected data item.

6. The method of claim 1, the electronic device is a personal communications device that displays an ordered list of data items, specifying the destination position of the selected display item by moving the selected display item to a different location in the ordered list.

7. The method of claim 6, selecting the display item by highlighting the display item.

8. A method for reordering user entered data items displayed on a display menu of a portable personal communications device, comprising:
selecting a data item to be relocated; pg,13
repositioning the selected data item to a new position on the display menu by moving the selected data item to the new position with an input of the electronic device; and
inserting the selected data item into the new position by entering an insert input of the electronic device after moving the selected data item to the new position.

9. The method of claim 8, selecting the data item by grabbing it with an input of the device.

10. The method of claim 8, selecting the data item by displaying a visual attribute near the selected data item.

11. The method of claim 8, repositioning the selected data item by scrolling the selected data item to the new position.

12. The method of claim 9, repositioning the selected data item by dragging the selected data item to the new position pg,14

13. A portable electronic device having processor, memory and a display, comprising:
a plurality of display items displayed on the display;
a display item selection input for selecting a display item to be relocated on the display;
a display item relocation input for designating a new location on the display for the selected display item;
a display item insertion input for inserting the selected data item in the new location,
whereby a user of the electronic device can selectively move display items about the display.

14. The electronic device of claim 13, the plurality of display items comprises a list of user entered data items stored in the memory of the electronic device.

15. The electronic device of claim 13, the display item selection input is an input key, the display item relocation input is a scrolling input, and the display item insertion input is an input key.

16. The electronic device of claim 13, the plurality of display items comprises an ordered list of user entered data items. pg,15

17. The electronic device of claim 13, the plurality of display items comprises a list of stored names.

18. The electronic device of claim 13, the plurality of display items comprises a plurality of stored menu entries.

19. The electronic device of claim 13, portable electronic device is personal communications device.

20. The electronics device of claim 13, a visual attribute displayed in association with a selected display item.
